(19) United States
(12) Patent Application Publication
(10) Pub. No.: US 2026/0333419 A1
(43) Pub. Date: Oct. 22, 2026

(54) SCHEDULING-REQUEST-BASED ACCESS PROCEDURE

(71) Applicant: QUALCOMM Incorporated, San Diego, CA (US)

(72) Inventors: Navid ABEDINI, Basking Ridge, NJ (US); Jianghong LUO, Skillman, NJ (US); Tao LUO, San Diego, CA (US); Xiaoxia ZHANG, San Diego, CA (US); Junyi LI, Greentown, PA (US); Mostafa KHOSHNEVISAN, San Diego, CA (US); Sony AKKARAKARAN, Poway, CA (US)

(21) Appl. No.: 19/372,804

(22) Filed: Oct. 29, 2025

Related U.S. Application Data
(60) Provisional application No. 63/790,441, filed on Apr. 17, 2025.

(51) Int. Cl. H04W 74/04; H04W 76/10

(52) U.S. Cl. CPC H04W 74/04; H04W 76/10

(57) ABSTRACT

Various aspects of the present disclosure generally relate to wireless communication. In some aspects, a first network entity may receive configuration information for a scheduling-request-based access procedure. The first network entity may transmit a scheduling request as part of the scheduling-request-based access procedure. The first network entity may establish an active connection with a second network entity based on the scheduling-request-based access procedure or based on a fallback random access channel procedure performed after initiating the scheduling-request-based access procedure. Numerous other aspects are described.

### CROSS-REFERENCE TO RELATED APPLICATION

This Patent Application claims priority to U.S. Provisional Patent Application No. 63/790,441, filed on Apr. 17, 2025, entitled “SCHEDULING-REQUEST-BASED ACCESS PROCEDURE,” and assigned to the assignee hereof. The disclosure of this prior Provisional Application is considered part of and is incorporated by reference into this Patent Application in its entirety.

### FIELD OF THE DISCLOSURE

Aspects of the present disclosure generally relate to wireless communication and specifically relate to techniques, apparatuses, and methods associated with a scheduling-request-based access procedure.

### INTRODUCTION

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Fixed wireless access (FWA) and consumer premises equipment (CPE) devices may provide an alternative to traditional wired connections for delivering high-speed internet to homes and businesses. FWA devices may enable the delivery of broadband services through wireless connectivity, typically utilizing cellular networks such as 4G LTE, 5G NR, and future 6G standards. CPE devices, which include routers and modems, may serve as an interface between a wireless network and a local environment, offering Wi-Fi or Ethernet connectivity to end-user devices within a premises.

In the context of wireless communication, the process of connecting and reconnecting devices to the network (e.g., via a network entity such as a network node) is important for maintaining seamless and efficient communication. A user equipment, an FWA device, and a CPE device may employ a random access channel procedure for initial access and reconnection procedures.

### SUMMARY

The systems, methods, and devices of this disclosure each have several innovative aspects, no single one of which is solely responsible for the desirable attributes disclosed herein.

Some aspects described herein relate to a method of wireless communication performed by a first network entity. The method may include receiving configuration information for a scheduling-request-based access procedure. The method may include transmitting, based on the configuration information, a scheduling request as part of the scheduling-request-based access procedure. The method may include establishing an active connection with a second network entity based on the scheduling-request-based access procedure or based on a fallback random access channel (RACH) procedure performed after initiating the scheduling-request-based access procedure.

Some aspects described herein relate to a first network entity. The first network entity may include a processing system. The processing system may be configured to receive configuration information for a scheduling-request-based access procedure. The processing system may be configured to transmit, based on the configuration information, a scheduling request as part of the scheduling-request-based access procedure. The processing system may be configured to establish an active connection with a second network entity based on the scheduling-request-based access procedure or based on a fallback RACH procedure performed after initiation of the scheduling-request-based access procedure.

Some aspects described herein relate to a non-transitory computer-readable medium having instructions stored thereon. The instructions, when executed by a first network entity, may cause the first network entity to receive configuration information for a scheduling-request-based access procedure. The instructions, when executed by the first network entity, may cause the first network entity to transmit a scheduling request as part of the scheduling-request-based access procedure. The instructions, when executed by the first network entity, may cause the first network entity to establish an active connection with a second network entity based on the scheduling-request-based access procedure or based on a fallback RACH procedure performed after initiating the scheduling-request-based access procedure.

Some aspects described herein relate to an apparatus for wireless communication. The apparatus may include means for receiving configuration information for a scheduling-request-based access procedure. The apparatus may include means for transmitting a scheduling request as part of the scheduling-request-based access procedure. The apparatus may include means for establishing an active connection with a network entity based on the scheduling-request-based access procedure or based on a fallback RACH procedure performed after initiating the scheduling-request-based access procedure.

Aspects generally include a method, apparatus, system, computer program product, non-transitory computer-readable medium, user equipment, base station, network entity, network node, wireless communication device, or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

FIG. 1 is a diagram illustrating an example environment in which apparatuses or methods described herein may be implemented.

FIG. 2 is a diagram illustrating an example of a wireless communication network.

FIG. 3 is a diagram illustrating an example of a four-step random access procedure.

FIGS. 4 and 5 are diagrams illustrating examples associated with scheduling-request-based access procedures.

FIG. 6 is a diagram illustrating an example of resources associated with a scheduling-request-based access procedure.

FIGS. 7 and 8 are diagrams illustrating example processes performed, for example, at a first network entity or an apparatus of a first network entity.

FIGS. 9 and 10 are diagrams of example apparatuses for wireless communication.

### DETAILED DESCRIPTION

In wireless communication systems, reconnection procedures for stationary network entities, such as customer premises equipment (CPE) devices or fixed wireless access (FWA) points, may be necessary to maintain efficient and reliable communication links. Some stationary network entities (e.g., CPE devices) may operate within a fixed location or premises and provide connectivity to other devices within the premises. These network entities may perform frequent reconnection attempts to the network due to managing a high volume of traffic. That is, some stationary network entities may perform more frequent reconnection procedures as compared to mobile network entities, such as a user equipment (UE).

A random access channel (RACH) procedure may not be suited for some stationary network entities. For example, communications between a CPE device and another network entity (e.g., a base station or other network node) may have static (or more static than communications between a mobile network entity and a network node) timing advance (TA) and transmission (TX) power configurations, which may differ from the variable conditions experienced by mobile UEs. Therefore, using RACH procedures by static network entities may result in unnecessary resource overhead and inefficiency, as RACH procedures may accommodate the mobile characteristics of UEs, including mobility-induced round-trip latency and dynamic timing advance estimation.

Additionally, stationary network entities and mobile network entities contending for resources for a RACH procedure may increase a latency and energy consumption for both the stationary and mobile network entities. Moreover, because stationary network entities often perform reconnection procedures frequently, shared RACH resources between stationary and mobile network entities may degrade a performance of the mobile network entity RACH procedures.

Various aspects relate generally to connection and reconnection procedures for stationary network entities, such as CPE or FWA devices. Some aspects more specifically relate to a scheduling-request-based access procedure. That is, instead of transmitting a RACH preamble message to initiate a reconnection procedure (e.g., a RACH procedure), a first network entity (e.g., that is stationary) may instead transmit a scheduling request. In particular, the first network entity (e.g., a stationary network entity) may receive configuration information for the scheduling-request-based access procedure; transmit, based on the configuration information, a scheduling request as part of the scheduling-request-based access procedure; and establish an active connection with a second network entity based on the scheduling-request-based access procedure or based on a fallback RACH procedure performed after initiating the scheduling-request-based access procedure. In some cases, the first network entity may determine to perform the scheduling-request-based access procedure rather than a conventional RACH procedure based on satisfaction of one or more conditions, from a plurality of conditions, for initiating the scheduling-request-based access procedure. In some aspects, the conditions for initiating the scheduling-request-based access procedure may include factors such as signal quality of a downlink reference signal exceeding a threshold, a validity of stored timing advance information, specific use cases or causes for access, a property of arrival data such as priority or latency requirements, proximity to the next scheduling request occasion, and number of previous scheduling request transmission attempts.

Particular aspects of the subject matter described in this disclosure can be implemented to realize one or more potential technical advantages. By employing a scheduling-request-based access procedure tailored to stationary network entities, the described techniques may enable the stationary network entities to perform a reconnection procedure that is more efficient than a RACH procedure by reducing signaling overhead (e.g., as the scheduling request transmission spans fewer resources as compared to a RACH preamble transmission). Additionally, enabling some stationary network entities to perform scheduling-request-based access procedures may conserve network resources by avoiding the extensive use of preambles and guard periods that are tailored for mobile network entities but are unnecessary for stationary network entities, thereby optimizing the use of spectrum and reducing energy consumption.

Additionally, by using a plurality of conditions to determine the appropriate access procedure (e.g., a scheduling-request-based access procedure or a RACH procedure), network entities may dynamically select a procedure for reconnection, which may maintain network efficiency under varying network conditions. By enabling network entities to utilize scheduling-request-based access procedures, wireless communication systems may facilitate improved network efficiency, reduced latency, and more effective utilization of network and processing resources, contributing to more sustainable network operations.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence devices). Aspects may be implemented in chip-level components, modular components, non-modular components, non-chip-level components, device-level components, or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, or summers). Aspects described herein may be practiced in a wide variety of devices, components, systems, distributed arrangements, or end-user devices of varying size, shape, and constitution.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

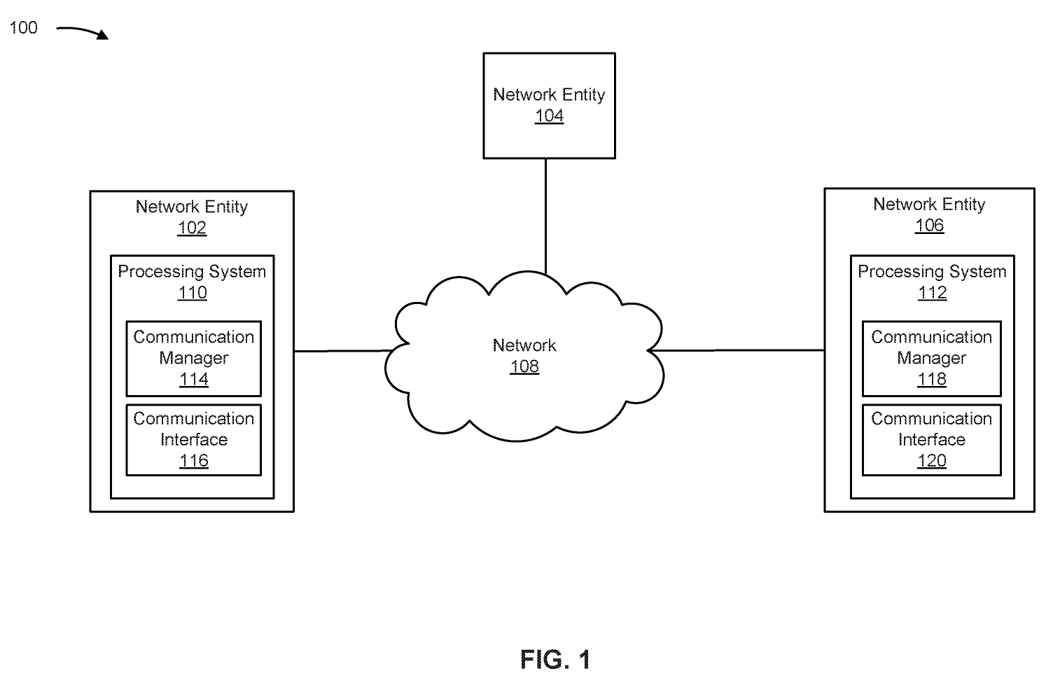

FIG. 1 is a diagram illustrating an example environment 100 in which apparatuses or methods described herein may be implemented. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary or mobile. The network 108 may include wired communication connections, wireless communication connections, or a combination of wired and wireless communication connections.

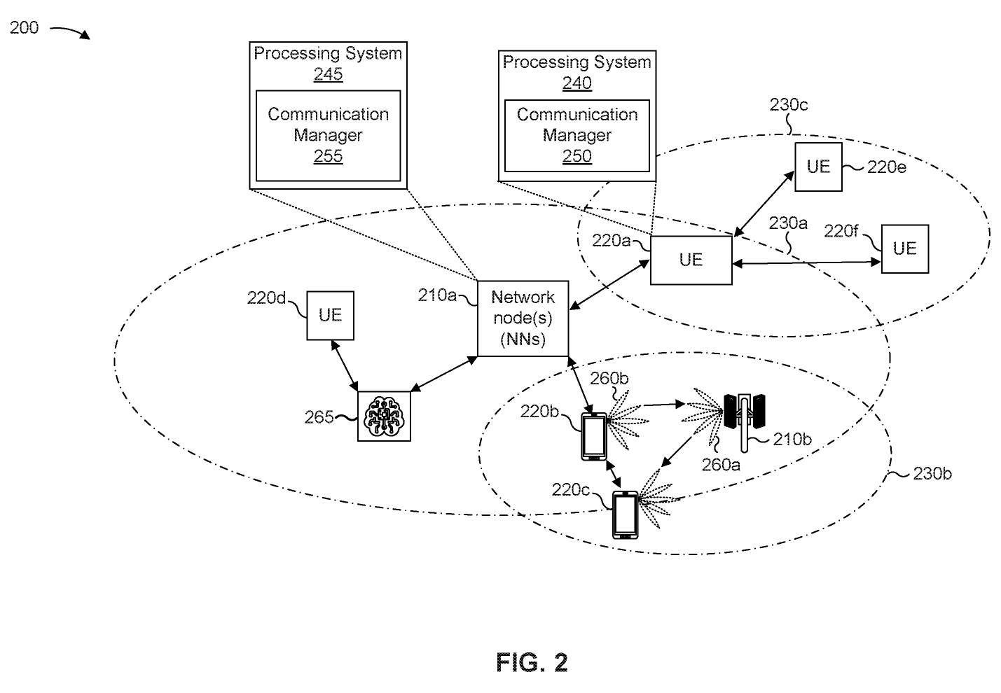

The network 108 may include, for example, a cellular network (e.g., a Long-Term Evolution (LTE) network, a code-division multiple access (CDMA) network, a 4G network, a 5G network, a 6G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a RedCap device, an enhanced reduced capability (eRedCap) device, an ambient IoT device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in or currently operating in the network. Rather, a network entity may be any entity that is capable of communicating or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, or a second processing entity, among other examples.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, or a third component configured to provide the output information to other systems or components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a processing system may include at least one memory, at least one communication interface, or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, or a third component configured to output the one or more outputs to one or more other components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, or a transceiver, among other examples. For example, a communication interface may include one or more transceivers, one or more receivers, or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, or a modulation component, among other examples.

A communication interface may include a transmission component or a reception component. For example, a communication interface may include a transceiver or one or more separate receivers or transmitters that enable a network entity to communicate with other devices, such as via a wired connection, a wireless connection, or a combination of wired and wireless connections. In some examples, a communication interface may include one or more radio frequency reflective elements or one or more radio frequency refractive elements. The communication interface may enable the network entity to receive information from another apparatus or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), or a serial peripheral interface (SPI), among other examples.

As described herein, a network entity (e.g., the network entity 102 or the network entity 106) may be configured to perform one or more operations. Reference to a network entity being configured to perform one or more operations may refer to a processing system of the network entity being configured to perform the one or more operations or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, or at least one communication interface, among other examples, that are configured to perform one or more (or all) of the one or more operations, or any combination thereof. Where reference is made to the network entity or the processing system being configured to perform operations, the network entity or the processing system may be configured to cause one component to perform all operations, or to cause more than one component to collectively perform the operations. When the network entity or the processing system is configured to cause more than one component to collectively perform the operations, each operation need not be performed by each of those components (e.g., different operations may be performed by different components) or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 or the communication interface 116 to) receive configuration information for a scheduling-request-based access procedure; transmit a scheduling request as part of the scheduling-request-based access procedure; and establish an active connection with a second network entity (e.g., the network entity 104 or the network entity 106) based on the scheduling-request-based access procedure or based on a fallback RACH procedure performed after initiating the scheduling-request-based access procedure. Additionally, or alternatively, the network entity 106 or the communication manager 118 may perform one or more other operations described herein.

The number and arrangement of entities shown in FIG. 1 are provided as one or more examples. In practice, there may be additional network entities or networks, fewer network entities or networks, different network entities or networks, or differently arranged network entities or networks than those shown in FIG. 1. Furthermore, the network entity 102, 104, and 106 may be implemented using a single apparatus or multiple apparatuses.

FIG. 2 is a diagram illustrating an example of a wireless communication network 200. The wireless communication network 200 may be or may include elements of a 5G network or a 6G network, among other examples. The wireless communication network 200 may include multiple network nodes 210. For example, in FIG. 2, the wireless communication network 200 includes multiple network nodes 210, including a network node 210a and a network node 210b (each of which also may be referred to herein simply as a “network node 210”). The network nodes 210 may support communications with multiple UEs 220. For example, in FIG. 2, the network nodes 210 support communication with a UE 220a, a UE 220b, a UE 220c, a UE 220d, a UE 220e, and a UE 220f (each of which also may be referred to herein simply as a “UE 220”). In some examples, a UE 220 also may communicate with other UEs 220 and a network node 210 also may communicate with a core network and with other network nodes 210. A network node 210 and a UE 220 may be examples of a network entity described herein, such as the network entity 102, the network entity 104, or the network entity 106.

The network nodes 210 and the UEs 220 of the wireless communication network 200 communicate using the electromagnetic spectrum, which may be subdivided into various licensed or unlicensed operating bands, frequency ranges, component carriers, or channels that define associated frequencies available for communications. In some examples, each of the network nodes 210 and the UEs 220 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 210 or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system. As shown in FIG. 2, each UE 220 includes a processing system 240 and each network node 210 includes a processing system 245. A processing system (for example, the processing system 240 or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 or the processing system 245 may include or implement one or more of the modems. The processing system 240 and the processing system 245 also may include or be coupled with multiple radios (collectively “the radio”), multiple RF chains, or multiple transceivers, each of which may in turn be coupled with one or more of multiple antennas. In some examples, one or more processors of the processing system 240 or the processing system 245 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 240 or by the processing system 245).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 210 and the UE 220.

A network node 210 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may include a single standalone base station or a single TRP that operates with a full radio protocol stack to enable or facilitate communication between a UE 220 and a core network of the wireless communication network 200.

Alternatively, and as also shown, a network node 210 may be a disaggregated network node 210 (sometimes referred to as a disaggregated base station), having a disaggregated architecture, meaning that the network node 210 may operate with a radio protocol stack that is physically distributed or logically distributed among two or more nodes in the same geographic location or in different geographic locations. In some deployments, disaggregated network nodes 210 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 210 of the wireless communication network 200 may include one or more CUs, one or more DUs, and one or more RUs. A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical RACH (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. In some examples, a single network node 210 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 200 may be a heterogeneous network that includes network nodes 210 of various types. Different types of network nodes 210 may generally operate on the same or different operating bands, transmit at different power levels, or serve different coverage areas, each of which may be referred to as or associated with a particular cell 230 (for example, a cell 230a and a cell 230b).

The UEs 220 may be physically dispersed throughout the coverage area of the wireless communication network 200, and each UE 220 may be stationary or mobile. A UE 220 may be, may include, or also may be referred to as an access terminal, a mobile station, a client device, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 200.

Some UEs 220 may be classified according to different categories in association with different complexities or different capabilities. UEs 220 in a first category may be associated with relatively low complexity or cost such as NB-IoT devices or eMTC UEs. UEs 220 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 200. A third category of UEs 220 may have mid-tier complexity or capabilities (for example, capabilities between that of the UEs 220 of the first category and the UEs 220 of the second category). A UE 220 of the third category may be referred to as a reduced capability UE (“RedCap UE”), a mid-tier UE, an NR-Light UE, or an NR-Lite UE, among other examples.

In some cases, a UE 220 may correspond to a stationary network entity. For example, a UE 220 may correspond to an FWA device, CPE devices, or a cable modem. In some cases, the stationary network entities may be deployed within fixed locations such as homes or businesses. Unlike mobile network entities (e.g., mobile UEs 220), stationary network entities may be connected to a constant power supply, alleviating concerns related to power consumption. This characteristic may allow stationary network entities to focus on achieving high data rates and maintaining resource efficiency, which may be critical for delivering robust and reliable broadband services.

Stationary network entities, including FWA, CPE devices, and cable modems, may be designed to support high data rate requirements, making resource efficiency a paramount consideration. In some cases, a stationary network entity may be configured to provide high-speed internet access over wireless connections. For example, the UE 220a may correspond to a stationary network entity, and may be configured to provide wireless connectivity to one or more other UEs 220 within a cell 230c provided by the UE 220a. In some implementations, the UE 220a may provide 5G/6G over coaxial cable (e.g., the UE 220a may correspond to a cable modem that is configured to provide wireless connectivity over a coaxial cable.

If the UE 220a corresponds to a stationary network entity, the UE 220a may communicate with the network node 210a via a wireless connection. This wireless connection may facilitate the transmission and reception of high-speed data, enabling the network node 210 to support the cell 230c. Additionally, the UE 220a may provide connectivity to one or more other devices within a premises (e.g., the UE 220e and the UE 220f), such as over a WiFi connection, serving as a central hub for distributing high-speed internet access to various devices within the home or business environment.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts. A bandwidth part may be a block of frequency domain resources (for example, a continuous set of resource blocks within a full component carrier bandwidth) that may be configured at a UE-specific level. A UE 220 may be configured with both an uplink bandwidth part and a downlink bandwidth part (which may be the same or different). Each bandwidth part may be associated with its own numerology (indicating a sub-carrier spacing (SCS) and cyclic prefix). A bandwidth part may be dynamically configured or activated (for example, by a network node 210 transmitting a downlink control information (DCI) configuration to the one or more UEs 220) or reconfigured (for example, in real-time or near-real-time) according to changing network conditions in the wireless communication network 200 or specific requirements of one or more UEs 220. An active bandwidth part defines the operating bandwidth of the UE 220 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 210 to a UE 220. DCI generally contains the information the UE 220 needs to identify resource blocks in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 220) from a network node 210 to a UE 220. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a cyclic prefix-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM, 128-QAM, or 256-QAM, among other examples) for a downlink signal or an uplink signal. For example, the network node 210 may select an MCS for a downlink signal in accordance with UCI received from the UE 220 or may transmit, to the UE 220, an indication of an MCS to be applied for an uplink signal.

A network node 210 or a UE 220 (such as by using the processing system 245 or the processing system 240, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 210 or the UE 220 (for example, using the processing system 245 or the processing system 240, respectively, or one or more coupled encoders or modems) may perform a channel coding operation or a forward error correction (FEC) operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 or one or more modems) may further perform spatial processing (for example, precoding) on the encoded information to generate one or more processed or precoded signals for downlink or uplink transmission, respectively. In some examples, the network node 210a or the UE 220a may perform codebook-based precoding or non-codebook-based precoding. Codebook-based precoding may involve selecting a precoder (for example, a precoding matrix) using a codebook. For example, the network node 210a may provide precoding information indicating which precoder, defined by the codebook, is to be used by the UE 220a. Non-codebook-based precoding may involve selecting or deriving a precoder based on, or otherwise associated with, one or more downlink or uplink signal measurements. The network node 210a or the UE 220a may transmit the processed downlink or uplink signals, respectively, via one or more antennas.

The network node 210a or the UE 220a may receive uplink signals or downlink signals, respectively, via one or more antennas. The network node 210a or the UE 220a (for example, using the processing system 245 or the processing system 240, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 210 or the UE 220 via the downlink or uplink signals. The network node 210a or the UE 220a (for example, using the processing system 245 or the processing system 240, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 220 and a network node 210 may perform MIMO communication. MIMO communication generally refers to transmitting or receiving multiple signals (such as multiple layers or multiple data streams) simultaneously over the same time and frequency resources. A network node 210 or a UE 220 may communicate using single-user MIMO or multi-user MIMO (MU-MIMO), the latter of which being used by a network node 210 to simultaneously transmit signals to multiple UEs 220. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 210 may generate one or more beams 260a, and a UE 220 may generate one or more beams 260b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 210 or a UE 220 may implement massive MIMO, which may be associated with an increased (for example, “massive”) quantity of antennas at the network node 210 or at the UE 220, such as in a network implementing mmWave technology, which enables more precise beamforming or reduced interference. In some examples, the wireless communication network 200 may implement multi-TRP (mTRP) operation (including redundant transmission or reception on multiple TRPs) or non-coherent joint transmission (NC-JT).

The network node 210 and the UE 220 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 210 transmitting signals (for example, SSBs or other signals) via respective beams (for example, of the beams 260 of the network node 210) and the UE 220 receiving and measuring the signal(s) via respective beams of multiple beams (for example, from the beams 260 of the UE 220) to identify a best beam (or beam pair) for communication between the UE 220 and the network node 210. A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified or defined via one or more spatial parameters, such as a transmission configuration indicator (TCI) state or a quasi-co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 265 (for example, one or more network nodes 210, one or more UEs 220, one or more servers, or one or more components of a cloud computing network, among other examples). For example, in a deployment in which AI/ML functionality is performed independently at a device 265, sometimes referred to as “overlay AI/ML,” the AI/ML model (or an instance or portion of the AI/ML model) may be deployed at a UE 220 (for example, by the processing system 240), a network node 210 (for example, by the processing system 245), one or more servers, or one or more components of a cloud computing network, among other examples. Additionally, or alternatively, in a deployment where AI/ML functionality is coordinated between different devices 265, sometimes referred to as “coordinated AI/ML,” or performed at all device and network layers, sometimes referred to as “native AI/ML,” the AI/ML model (or an instance of the AI/ML model) may be deployed at multiple devices 265 (for example, a first portion of the AI/ML model may be deployed at a UE 220 and a second portion of the AI/ML model may be deployed at a network node 210). In other examples of coordinated AI/ML or native AI/ML, a first AI/ML model may be deployed at a UE 220 and a second AI/ML model may be deployed at a network node 210. The AI/ML model(s) may be configured to enhance various aspects of the wireless communication network 200 (for example, to increase privacy, reliability, or efficient use of network bandwidth, or to reduce latency, among other examples). For example, the AI/ML model(s) may be trained to identify patterns or relationships in data corresponding to the wireless communication network 200, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 220, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a first network entity may include the communication manager 250 or the communication manager 255. As described in more detail elsewhere herein, the communication manager may receive configuration information for a scheduling-request-based access procedure; transmit a scheduling request as part of the scheduling-request-based access procedure; and establish an active connection with a second network entity based on the scheduling-request-based access procedure or based on a fallback RACH procedure performed after initiating the scheduling-request-based access procedure. Additionally, or alternatively, the communication manager may perform one or more other operations described herein.

In some aspects, a first network entity may include the communication manager 250 or the communication manager 255. As described in more detail elsewhere herein, the communication manager may transmit, to a second network entity, configuration information for a scheduling-request-based access procedure; receive a scheduling request as part of the scheduling-request-based access procedure; and establish an active connection with the second network entity based on the scheduling-request-based access procedure or based on a fallback RACH procedure performed after initiating the scheduling-request-based access procedure. Additionally, or alternatively, the communication manager may perform one or more other operations described herein.

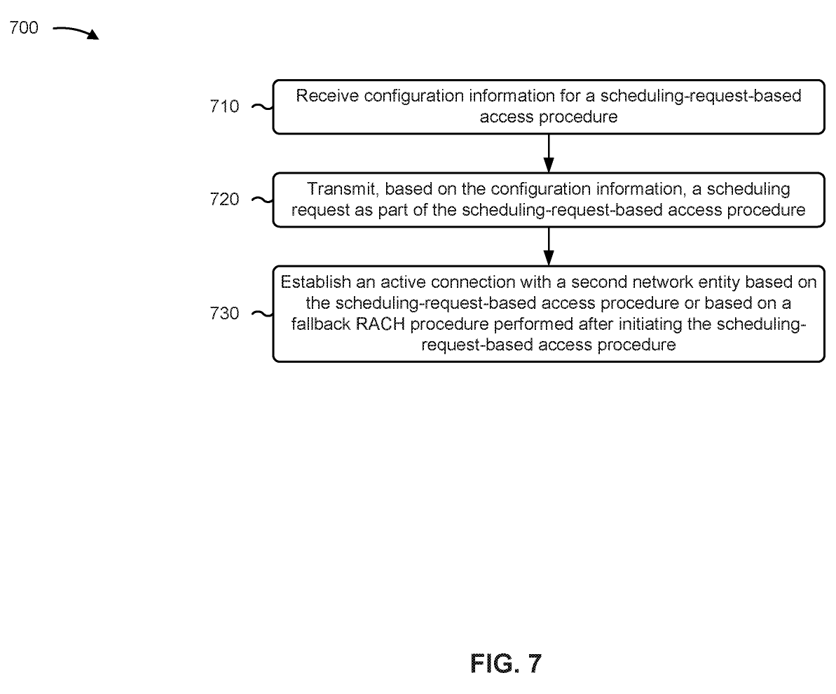

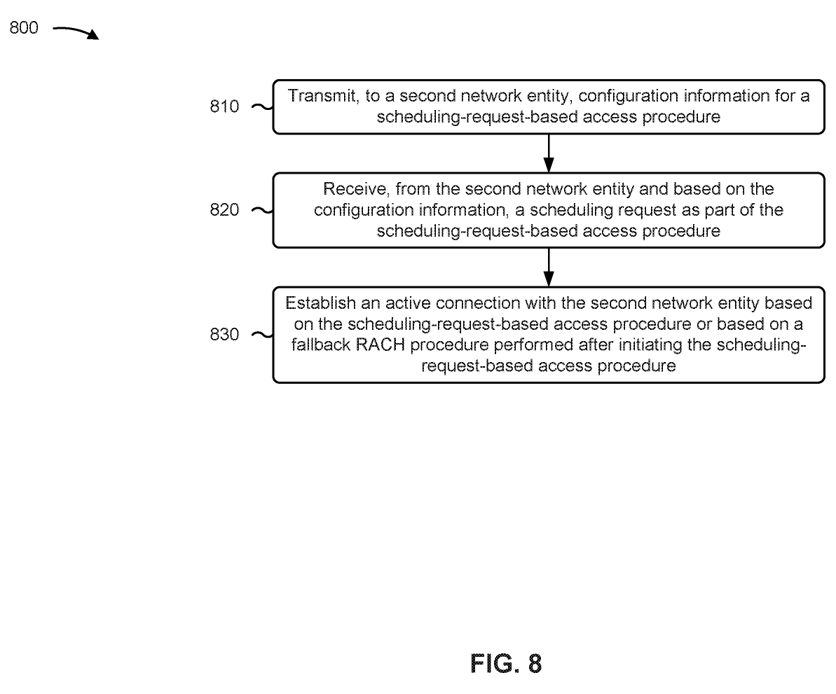

The network entity 102, the processing system 110 of the network entity 102, the network entity 106, the processing system 112 of the network entity 106, the network node 210, the processing system 245 of the network node 210, the UE 220, the processing system 240 of the UE 220, or any other component(s) of FIGS. 1-2 may implement one or more techniques or perform one or more operations associated with scheduling-request-based access procedures, as described in more detail elsewhere herein. For example, the processing system 110 of the network entity 102, the processing system 112 of the network entity 106, the processing system 245 of the network node 210, or the processing system 240 of the UE 220 may perform or direct operations of, for example, process 700 of FIG. 7, process 800 of FIG. 8, or other processes as described herein (alone or in conjunction with one or more other processors). In some aspects, a network entity described herein is the UE 220a, is included in the UE 220a, or includes one or more components of the UE 220a shown in FIG. 2. Additionally, or alternatively, a network entity described herein is the network node 210, is included in the network node 210, or includes one or more components of the network node 210 shown in FIG. 2.

Memory of the network node 210 may store data and program code (or instructions) for the network node 210. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium having instructions stored thereon. For example, the instructions, when executed by the UE 220 or the network node 210 (for example, by one or more processors such as, of the processing system 110, the processing system 112, the processing system 245, or the processing system 240) may cause the UE 220 or the network node 210 to perform process 700 of FIG. 7, process 800 of FIG. 8, or other processes as described herein. In some examples, executing instructions may include running the instructions, converting the instructions, compiling the instructions, or interpreting the instructions, among other examples.

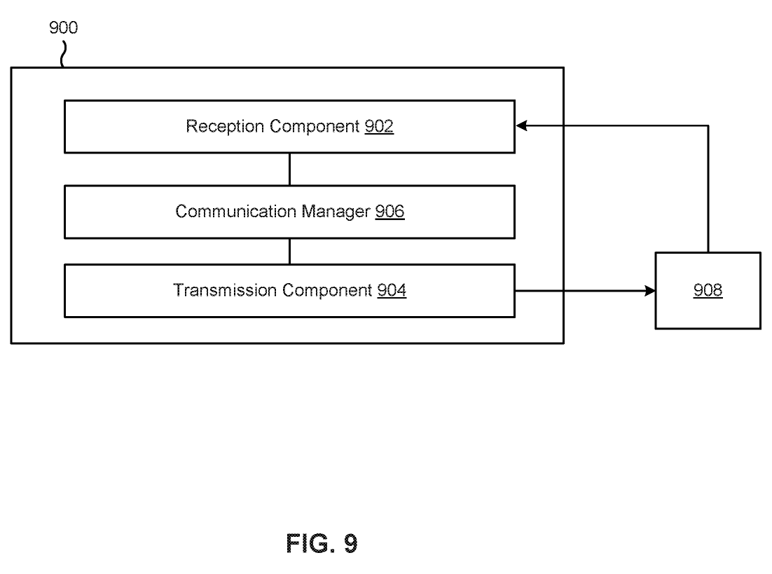

In some aspects, the UE 220a may correspond to a first network entity (e.g., that is stationary) and may include means for receiving configuration information for a scheduling-request-based access procedure; means for transmitting, based on the configuration information, a scheduling request as part of the scheduling-request-based access procedure; or means for establishing an active connection with a second network entity based on the scheduling-request-based access procedure or based on a fallback RACH procedure performed after initiating the scheduling-request-based access procedure. In some aspects, the means for the first network entity to perform operations described herein may include, for example, one or more of communication manager 250, processing system 240, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

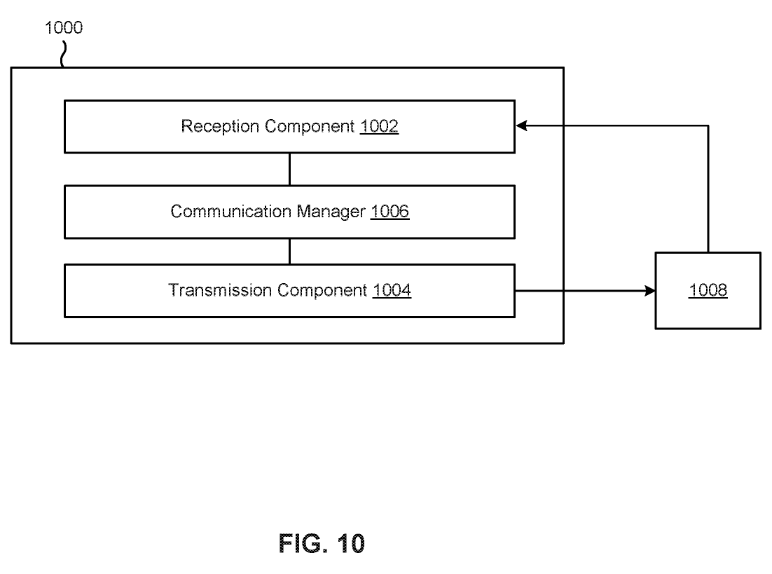

In some aspects, the network node 210a may correspond to a first network entity and may include means for transmitting, to a second network entity, configuration information for a scheduling-request-based access procedure; means for receiving, from the second network entity and based on the configuration information, a scheduling request as part of the scheduling-request-based access procedure; or means for establishing an active connection with the second network entity based on the scheduling-request-based access procedure or based on a fallback RACH procedure performed after initiating the scheduling-request-based access procedure. In some aspects, the means for the first network entity to perform operations described herein may include, for example, one or more of communication manager 255, processing system 245, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

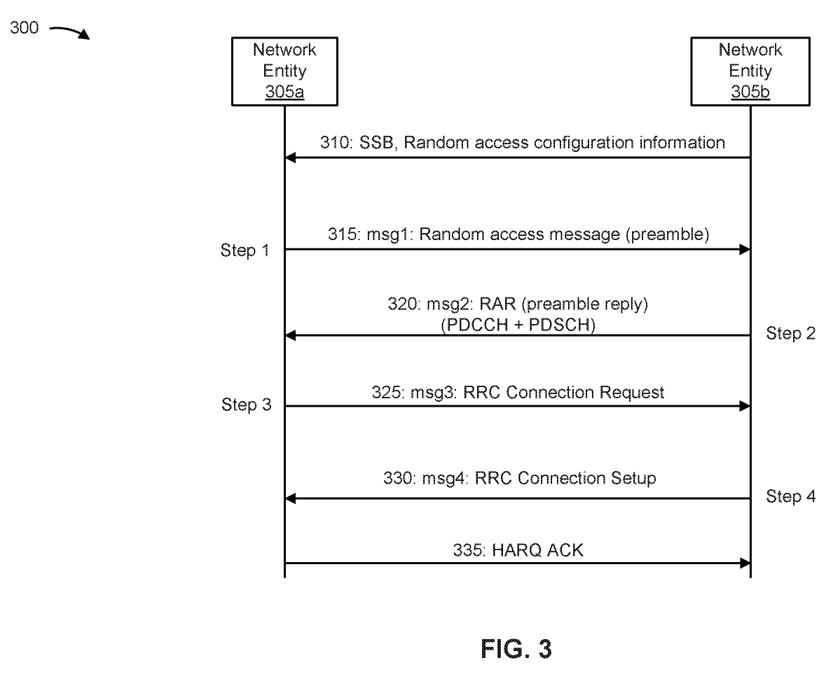

FIG. 3 is a diagram illustrating an example 300 of a four-step random access procedure. As shown in FIG. 3, a network entity 305a and a network entity 305b may communicate with one another to perform the four-step random access procedure. In some cases, the network entity 305a may be a UE, a CPE, or a an FWA device. Additionally, the network entity 305b may correspond to a network node.

As shown by reference number 310, the network entity 305b may transmit, and the network entity 305a may receive, one or more SSBs and random access configuration information. In some aspects, the random access configuration information may be transmitted in or indicated by system information (e.g., in one or more system information blocks (SIBs)) or an SSB, such as for contention-based random access. Additionally, or alternatively, the random access configuration information may be transmitted in an RRC message or a physical downlink control channel (PDCCH) order message that triggers a RACH procedure, such as for contention-free random access. The random access configuration information may include one or more parameters to be used in the random access procedure, such as one or more parameters for transmitting a random access message (RAM) or one or more parameters for receiving a random access response (RAR).

As shown by reference number 315, the network entity 305a may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 315, the network entity 305a may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

The preamble may be designed to support initial access of mobile network entities that do not have any stored timing alignment information (e.g., that do not have a valid timing advance stored). The preamble may include a DFT-spread Zadoff-Chu (ZC) sequence and may include a relatively large cyclic prefix to accommodate the round-trip latency of the cell size before a timing advance adjustment. The preamble may also include a relatively long root sequence (e.g., a root sequence that includes 139 bits, 571 bits, 839 bits, or 1151 bits) spanning multiple symbols and resource blocks. The long root sequence may provide sufficient resolution for timing estimation and multiplexing capability among multiple users via different cyclic shifts.

As shown by reference number 320, the network entity 305b may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the network entity 305a in msg1). Additionally, or alternatively, the RAR may indicate a resource allocation to be used by the network entity 305a to transmit message 3 (msg3).

In some aspects, as part of the second step of the four-step random access procedure, the network entity 305b may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network entity 305b may transmit the PDSCH communication for the RAR, as scheduled by the PDCCH communication. The RAR may be included in a MAC protocol data unit (PDU) of the PDSCH communication.

As shown by reference number 325, the network entity 305a may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (e.g., an RRC connection request).

As shown by reference number 330, the network entity 305b may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by reference number 335, if the network entity 305a successfully receives the RRC connection setup message, the network entity 305a may transmit a HARQ ACK.

The four-step RACH procedure may not be suited to stationary network entities, such as CPEs or FWA devices, for several reasons. First, some stationary network entities may be sent to an idle or inactive state when there is no traffic for a prolonged period to free up network and physical resources, and enable more energy-efficient operation. Consequently, these network entities may perform reconnection procedures more frequently than mobile network entities due to higher traffic demand, making latency and overhead of reconnection procedures more critical.

Using the four-step RACH procedure for both stationary and mobile network entities may lead to increased contention between stationary network entities (such as CPEs or FWAs) and mobile network entities (such as UEs), resulting in larger latency and higher energy consumption for mobile network entities. Additionally, CPE devices may use more frequent uplink resources for faster connection, which may result in the CPE devices using separate and frequent uplink resources for access and reconnection attempts. Additionally, for reconnection attempts, some stationary network entities may already have valid timing advances and transmission power configurations, eliminating the need for extensive resource configurations tailored for unknown round-trip times.

Moreover, the random access message transmitted by the network entity 305a (e.g., the msg1) may be at least 2 symbols or 12 resource blocks. If the network entity 305a is a stationary network entity, the network entity 305a may require less than 2 symbols or 12 resource blocks for the initial message of an access procedure. That is, if the network entity 305a has a valid timing advance that is stored, a shorter initial message may be sufficient. That is, the initial message may not need to have a long cyclic prefix and guard time, as the network entity 305a may instead apply a known timing advance when transmitting the initial message. Additionally, the preamble may not need to provide accurate uplink timing estimation.

Therefore, some network entities may instead rely on access procedures that include a scheduling request (e.g., instead of a RACH preamble). The scheduling request may be more efficient, as a scheduling request may be as small as a single resource block. Accordingly, some network entities 305a (e.g., network entities that are stationary, network entities that are storing a valid timing advance) may perform a scheduling-request-based access procedure (e.g., as opposed to a RACH procedure, such as a four-step RACH procedure or a two-step RACH procedure).

As indicated above, FIG. 3 is provided as an example. Other examples may differ from what is described with regard to FIG. 3.

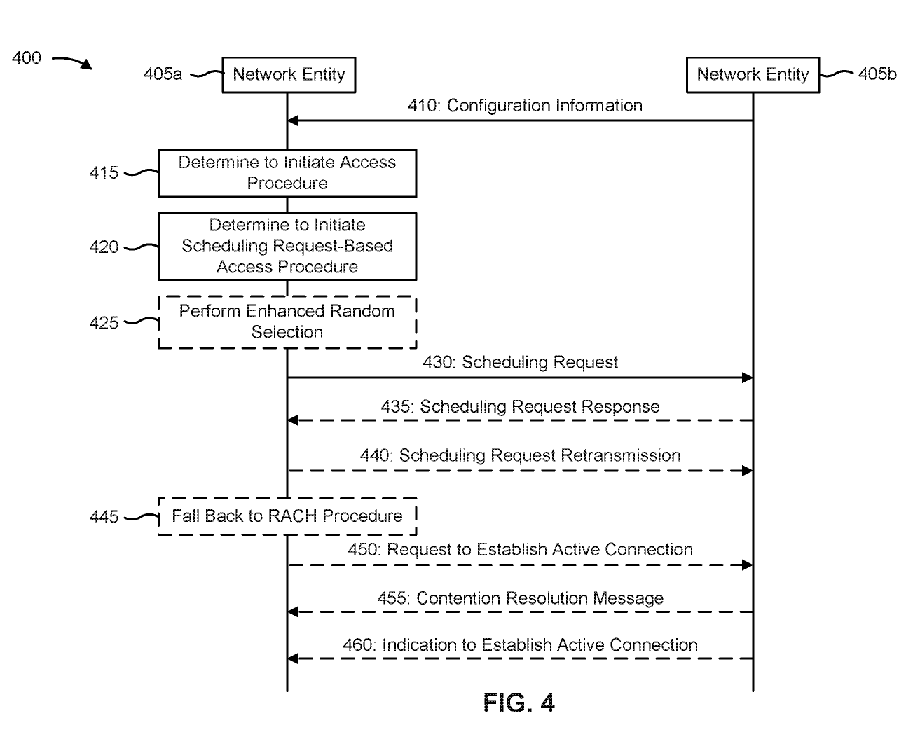

FIG. 4 is a diagram illustrating an example 400 associated with a scheduling-request-based access procedure. As shown in FIG. 4, a network entity 405a (e.g., a CPE device, an FWA device, or another stationary wireless communication device such as a cable modem) and a network entity 405b (e.g., a gNB or another network node described herein) may communicate with one another to perform the scheduling-request-based access procedure.

As shown by reference number 410, the network entity 405b may transmit, and the network entity 405a may receive, configuration information for a scheduling-request-based access procedure. In some cases, the configuration information may indicate, to the network entity 405a, a configuration for performing a scheduling-request-based access procedure with the network entity 405b.

The configuration information may indicate, to the network entity 405a, one or more scheduling-request-based access procedure configurations. For example, the configuration information may indicate different configurations for different access types (e.g., a first configuration for a contention-based scheduling-request-based access procedure and a second configuration for a contention-free scheduling-request-based access procedure). Additionally, or alternatively, the configuration information may indicate different configurations for different resources (e.g., for different resources for transmitting the scheduling request). Here, different configurations may be based on a tradeoff between resource efficiency versus robustness for noise or interference. In some cases, the configuration information may indicate different scheduling-request-based access procedure configurations for different latency, urgency, or robustness requirements. In some other cases, the configuration information may indicate different configurations that are each associated with different PUCCH formats (e.g., PUCCH format 0, PUCCH format 1), different periodicities of resources for transmitting the scheduling request, or different resource pools for contention-based scheduling-request-based access procedures, where each resource pool has a different number of resources in time, frequency, or cyclic shift domain. This allows for flexible and efficient allocation of resources based on the specific requirements of the network entity 405a.

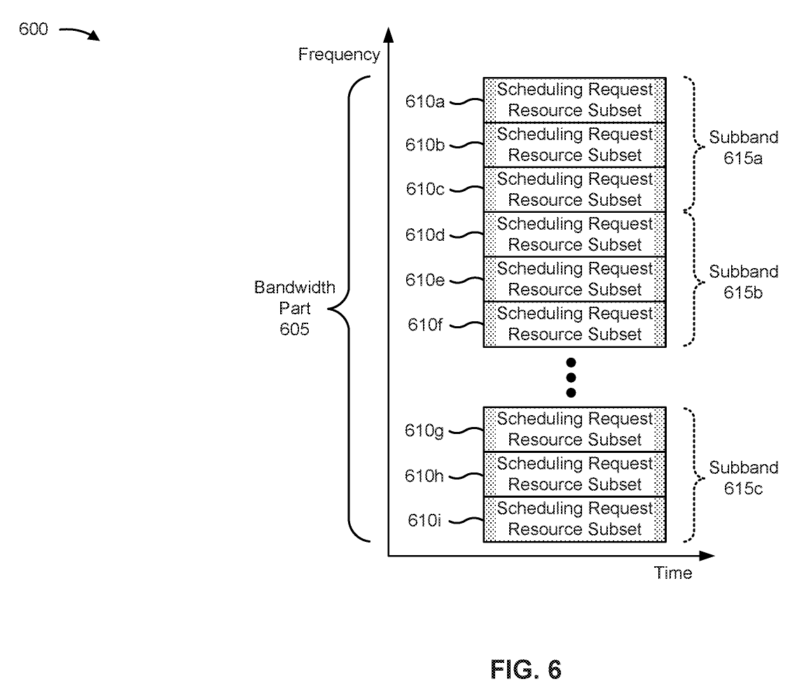

The configuration information may also indicate, to the network entity 405a, a plurality of conditions for initiating a scheduling-request-based access procedure (e.g., rather than a RACH procedure). The configuration information may also indicate, to the network entity 405a, resources for transmitting a scheduling request as part of the scheduling-request-based access procedure. FIG. 6 describes details related to the configuration information indicating the resources for transmitting the scheduling request. In some cases, the configuration may indicate a mapping between the resources for transmitting the scheduling request and an SSB.

Additionally, or alternatively, the configuration information may indicate one or more of the following: parameters for retransmitting the scheduling request (e.g., resources for the retransmitting, transmission power parameters for the retransmitting), parameters for a response to the scheduling request, and parameters for collision resolution (e.g., priority, etc.). For example, the configuration information may indicate parameters for handling retransmissions of the scheduling requests, the expected format and content of scheduling request responses, and criteria for resolving any contention that may arise during the scheduling-request-based access procedure.

The network entity 405b may transmit the configuration information within a UE-specific message. For example, the configuration information may be included within an RRC message (e.g., an RRC release message that includes or that does not include a suspendConfig information element), within a MAC-CE, within a multicast message, or within a broadcast message (e.g., within a SIB).

As shown by reference number 415, the network entity 405a may determine to initiate an access procedure. For example, the network entity 405a may initiate the access procedure based on being in an idle or an inactive state. That is, the network entity 405a may initiate the access procedure for initial access or an on-demand triggering of a common signal, or to initiate a data transmission (e.g., a small data transmission). In another example, the network entity 405a may initiate the access procedure when the network entity 405a is in a connected state (e.g., for beam failure recovery, for RRC connection re-establishment). Additionally, or alternatively, the network entity 405a may initiate the access procedure when the network entity 405a has previously communicated with the network entity 405b via an active connection, but does not currently have an active connection with the network entity 405b. Then (e.g., based on there being no traffic for the network entity 405a for more than a threshold amount of time) the network entity 405a may transition the connection between the network entity 405a and the network entity 405b from the active state to an inactive state. Here, the network entity 405a may determine to initiate an access procedure with the network entity 405b to activate the connection between the network entity 405a and the network entity 405b (e.g., to establish an active connection with the network entity 405b). In some cases, the network entity 405a may determine to initiate the access procedure based on detecting the presence of uplink data or a need to transmit data to the network entity 405b. This detection may trigger the initiation of an access procedure to re-establish an active connection with the network entity 405b.

As shown by reference number 420, the network entity 405a may determine to initiate a scheduling-request-based access procedure. In some cases, the network entity 405a may determine to initiate the scheduling-request-based access procedure based on determining to initiate an access procedure and determining that one or more conditions, from the plurality of conditions associated with initiating scheduling-request-based access procedures (e.g., indicated to the network entity 405a within the configuration information) being satisfied.

The plurality of conditions may include, for example, a signal quality of a downlink reference signal exceeding a threshold signal quality. Specifically, the signal quality may be determined based on the signal level of an associated downlink reference signal, such as an SSB, a DMRS, a CSI-RS, or a TRS. For instance, the network entity 405a may evaluate whether an RSRP or signal-to-interference-plus-noise ratio (SINR) of the downlink reference signal exceeds a threshold, indicating a strong and reliable signal. Additionally, the condition may be based on a change in RSRP or SINR over time. For example, if the change in RSRP or SINR is less than a specified threshold, indicating stable signal conditions, the change may satisfy the condition.

Additionally, the plurality of conditions may include the timing advance information stored at the network entity 405a being valid. The network entity 405a may determine the validity of a known or stored timing advance based on a timing advance validity timer (TAValidity-timer). The network entity 405a may reset the timing advance validity timer upon receiving a timing advance command from the network entity 405b or upon one or more successful uplink transmissions. In some cases, the timing advance validity timer may be configured as infinity, particularly if the network entity 405a is a stationary network entity that does not experience significant movement. Furthermore, the network entity 405a may assess the validity of the timing advance based on downlink timing drifting conditions. That is, if the downlink timing drift remains less than a threshold, the network entity 405a may determine that the timing advance information is valid. Additionally, the network entity 405a may utilize motion or location detection techniques, such as GNSS or other positioning methods, to determine whether the network entity 405a is stationary within a specified tolerance level. If the network entity 405a determines that it is stationary, the network entity 405a may determine that the stored or known timing advance information is valid, thereby satisfying the condition for initiating the scheduling-request-based access procedure.

Additionally, the plurality of conditions may include a priority or latency requirement of arrival data satisfying a threshold requirement. Arrival data may correspond to the data that has been received and buffered by the network entity 405a, awaiting transmission to the network entity 405b, and may include various types of data such as user-generated content, control messages, or application-specific information that requires timely and prioritized handling based on its properties, such as priority, latency requirements, and volume. The network entity 405a may evaluate properties of the arrival data, including the priority of the arrival data, a latency requirement of the arrival data, and the volume or latency of buffered arrival data. In some cases, the network entity 405a may determine to initiate the scheduling-request-based access procedure if the arrival data has at least a threshold priority (e.g., has high priority) or at least a threshold latency requirement (e.g., has tight latency requirements).

Additionally, the plurality of conditions may include a time until a next-occurring scheduling request occasion being less than a threshold time. For example, the network entity 405a may determine to initiate the scheduling-request-based access procedure if the time offset until the next-occurring scheduling request occasion is less than a threshold time. Additionally, or alternatively, the network entity 405a may determine to initiate the scheduling-request-based access procedure if the time until the next-occurring scheduling request occasion is less than the time until the next-occurring RACH occasion.

Additionally, the plurality of conditions may include a quantity of transmissions of the scheduling request being less than a threshold quantity. For example, the network entity 405a may determine to initiate the scheduling-request-based access procedure if the network entity 405a has transmitted less than a threshold quantity of retransmissions of the scheduling request. That is, if the network entity 405a has transmitted more than the threshold quantity of retransmissions, the network entity 405a may instead determine to perform the RACH procedure.

Additionally, the plurality of conditions may include an access use case or cause value associated with initiating the access procedure. For example, the network entity 405a may determine to perform the scheduling-request-based access procedure for initial access. Additionally, or alternatively, the network entity 405a may determine to perform the scheduling-request-based access procedure for initial access if the cause value is associated with data transmissions (e.g., MO_data, MT_data) or small data transmissions (MO_SDT, MT-SDT).

As shown by reference number 425, the network entity 405a may optionally perform an enhanced random selection. That is, the network entity 405a may determine the configuration for the scheduling-request-based access procedure from a plurality of configurations (e.g., indicated by the configuration information). In some cases, the network entity 405a may perform the enhanced random selection if the scheduling-request-based access procedure is a contention-based access procedure (e.g., if the set of resources for transmitting the scheduling request are shared among multiple network entities). Additionally, or alternatively, the network entity 405a may perform the enhanced random selection if the configuration information indicates a plurality of configurations for the scheduling-request-based access procedure.

The network entity 405a may determine the configuration for the scheduling-request-based access procedure based on the one or more conditions, from the plurality of conditions associated with initiating the scheduling-request-based access procedure, that are satisfied. In some cases, the thresholds or satisfaction conditions may be different for determining the configuration than for determining to initiating the scheduling-request-based access procedure.

As part of the enhanced random selection, the network entity 405a may select a subset of the set of resources for transmitting the scheduling request. That is, the configuration information may indicate, to the network entity 405a, a set of resources (e.g., that are not dedicated to the network entity 405a, that are shared among multiple network entities 405a) for transmitting the scheduling request. During the enhanced random selection, the network entity 405a may determine a subset of the resources for transmitting the scheduling request. Details related to selecting the subset of resources for transmitting the scheduling request are described below with reference to FIG. 6.

As shown by reference number 430, the network entity 405a may transmit, and the network entity 405b may receive, a scheduling request. In some cases, the network entity 405a may align the scheduling request based on a stored timing advance. That is, the network entity 405a may have an inactive or idle connection with the network entity 405b that is associated with a timing advance that is stored by the network entity 405a. Here, the network entity 405a may transmit the scheduling request based on the stored timing advance information. Additionally, the network entity 405a may adjust the timing for transmitting the scheduling request based on a downlink timing drift.

The network entity 405a may transmit the scheduling request via resources that are indicated by the configuration information. If the scheduling-request-based access procedure is a contention-free procedure, the network entity 405a may transmit the scheduling request via resources that are dedicated to the network entity 405a. Additionally, if the scheduling-request-based access procedure is a contention-based procedure, the network entity 405a may transmit the scheduling request via a subset of resources that are shared among multiple network entities.

In some cases, the network entity 405a may transmit the scheduling request according to spatial domain QCL information associated with the resources for transmitting the scheduling request. For dedicated resources (e.g., if the scheduling-request-based access procedure is a contention-free procedure), the network entity 405b may indicate, within the configuration information, that one or more downlink reference signals (e.g., SSBs, DMRSs) can be indicated for the dedicated PUCCH-SR resource as its spatial QCL reference signal. Here, the spatial properties of the scheduling request transmission may be similar to those of the indicated downlink reference signals. Additionally, for shared resources (e.g., if the scheduling-request-based access procedure is a contention-based procedure), the configuration information may indicate a mapping between downlink reference signals (e.g., SSBs, DMRSs) and the subsets of resources. Here, the network entity 405a may determine the spatial parameters for transmitting the scheduling request according to the mapping and based on the detected downlink reference signals. In some cases, multiple network entities may be divided into different groups, with different groups being allocated different sets of resources for scheduling request transmissions. Here, spatially separated network entities may be grouped together and allocated the same set of resources.

The scheduling request may be carried within a PUCCH message. In some cases, the PUCCH message may correspond to a PUCCH format 0 message or a PUCCH format 1 message. If the scheduling request is a PUCCH format 0 or a PUCCH format 1 message, the scheduling request may correspond to a sequence-based signal that carries up to 2 bits of UCI. PUCCH format 0 and PUCCH format 1 for scheduling requests typically use 1 resource block and support 12 cyclic shift indices with computer-generated sequences. PUCCH format 0 may span 1 to 2 symbols, while PUCCH format 1 may span 4 to 14 symbols.

As shown by reference number 435, the network entity 405b may optionally transmit, and the network entity 405a may receive, a scheduling request response. In some cases, the network entity 405b may transmit a PDCCH message that includes the scheduling request response (e.g., if the scheduling-request-based access procedure is contention-free). In some other cases, the network entity 405b may transmit a PDCCH message that includes a grant for a PDSCH message (e.g., if the scheduling-request-based access procedure is contention-based). Here, the network entity 405b may transmit, in accordance with the grant, a PDSCH message that includes the scheduling request response. Additionally, the network entity 405a may receive the scheduling request response based on monitoring for the PDSCH message in accordance with the grant.

The scheduling request response message may be scrambled using a radio network temporary identifier (RNTI). Accordingly, the network entity 405a may decode the scheduling request response message using the RNTI. In one example, the scheduling request response message may be scrambled using a cell RNTI (C-RNTI) that is stored by the network entity 405a. In another example, the scheduling request response message may be scrambled using a scheduling request resource RNTI (SRR-RNTI). The SRR-RNTI may be based on the subset of resources used for transmitting the scheduling request.

The scheduling request response may include one or more of an uplink grant for an RRC request message, a downlink grant for a contention resolution message, timing advance adjustment information (e.g., fine relative timing advance information within a field that includes a limited number of bits), feedback information related to the scheduling request (e.g., an ACK or a NACK), or retransmission information for the scheduling request. The retransmission information may include, for example, a power for a retransmission of the scheduling request, resources for the retransmission of the scheduling request, new configuration information for the retransmission of the scheduling request, or an indication for the first network entity to fall back to a RACH procedure to establish the active connection with the network entity 405b. In some cases, the network entity 405a may retransmit each retransmission of the scheduling request using an increased transmission power (e.g., until the scheduling request is transmitted using a maximum transmit power of the network entity 405a). In some cases, the scheduling request response may include the retransmission information if the network entity 405b fails to decode the scheduling request. Here, the scheduling request response may include a NACK and the retransmission information. In some cases, the scheduling request response may include a temporary C-RNTI (TC-RNTI) or a new C-RNTI.

In some cases, the scheduling request response may be based on an RAR format. Here, the scheduling request response may be scrambled using a random access RNTI (RA-RNTI) that is based on the resources (e.g., the time resources, the frequency resources) of the scheduling request transmission. The frequency index (e.g., for determining the RA-RNTI) of the scheduling request transmission may correspond to a starting resource block of the scheduling request transmission (e.g., the preamble index is an index based on the PUCCH cyclic shift or the root sequence parameter (u,v)). Alternatively, the frequency index of the scheduling request transmission may correspond to a starting resource block of a subband that contains the scheduling request (e.g., the preamble index is an index that is based on the PUCCH cyclic shift, the starting resource block index within the subset, and the root sequence parameter (u,v)). In some cases, the number of bits of the fields within the scheduling request response may be different from the number of bits of the fields within an RAR (e.g., the preamble index field, no timing advance field, or a timing advance field with fewer bits than the RAR). Further, the scheduling request response may include additional fields as compared to an RAR.

In some cases, the network entity 405a may establish an active connection with the network entity 405b based on receiving the scheduling request response. For example, if the access procedure is contention-free and the scheduling request response includes an ACK for the scheduling request, and the network entity 405a and network entity 405b do not perform the actions described with reference to 440, 445, 450 455, and 460, the network entity 405a may establish the active connection based on receiving the scheduling request response.

As shown by reference number 440, the network entity 405a may optionally transmit, and the network entity 405b may receive, a scheduling request retransmission. In some cases, the network entity 405a may transmit the scheduling request retransmission based on receiving a scheduling request response indicating for the network entity 405a to retransmit the scheduling request. In some other cases, the network entity 405a may transmit the scheduling request retransmission if the network entity 405a does not receive a scheduling request response that includes an ACK (e.g., within a window). That is, the configuration information may indicate a time window (e.g., a period of time) for receiving a scheduling request response. If the network entity 405a fails to detect the scheduling request response within the window (or fails to detect a scheduling request response that includes an ACK within the window), the network entity 405a may perform the scheduling request retransmission. In some cases, the network entity 405a may initiate a timer (e.g., start a timer) based on transmitting the scheduling request. If the timer expires prior to the network entity 405a detecting the scheduling request response (or prior to the network entity 405a detecting a scheduling request response that includes an ACK), the network entity 405a may retransmit the scheduling request.

The network entity 405a may retransmit the scheduling request using the same configuration or a different configuration as for a previous transmission of the scheduling request. For example, the network entity 405a may use the same or different resources for transmitting the scheduling request retransmission, the same or increased transmission power, or the same or a different PUCCH format. If the scheduling request response includes any retransmission information, the network entity 405a may transmit the scheduling request retransmission in accordance with the retransmission information. The network entity 405a may additionally determine the configuration based on the configuration information.

As shown by reference number 445, the network entity 405a may optionally fall back to a RACH procedure to establish the active connection with the network entity 405b. Here, the network entity 405a may transmit a RACH preamble (e.g., as described with reference to FIG. 3) as part of the RACH procedure. For example, if the scheduling request response includes an indication for the network entity 405a to fall back to the RACH procedure, the network entity 405a may switch from the scheduling-request-based access procedure to the RACH procedure to establish an active connection with the network entity 405b. In another example, the network entity 405a may fall back to the RACH procedure based on failing to detect a scheduling request response that includes an ACK of the scheduling request and based on the quantity of retransmissions of the scheduling request satisfying a threshold quantity. That is, the configuration information may indicate a threshold quantity of retransmissions of the scheduling request for the network entity 405b to perform prior to falling back to a RACH procedure. If the network entity 405b determines that the threshold quantity of scheduling retransmissions have been made without receiving a scheduling request response that includes an ACK, the network entity 405b may fall back to the RACH procedure. In another example, the network entity 405a may fall back to the RACH procedure based on reaching a maximum transmit power for transmitting the scheduling request retransmissions. For example, the network entity 405a may use power ramping for each subsequent scheduling request retransmission until a maximum transmit power of the network entity 405a is reached. Then, if the network entity 405a still fails to detect a scheduling request response that includes an ACK, the network entity 405a may fall back to a RACH procedure.

As shown by reference number 450, the network entity 405a may optionally transmit, and the network entity 405b may receive, a request to establish an active connection. The request to establish the active connection may correspond to an uplink message that includes an RRC request message for connection setup or connection resume. The network entity 405a may transmit the request to establish the active connection via a PUSCH message. In some cases, the network entity 405a may transmit the request to establish the active connection if the access procedure is for initial access, a short data transmission, or for transmitting on-demand other system information. In some cases, the network entity 405a may refrain from transmitting the request to establish the active connection if the access procedure is for on-demand SIB1 transmission, for transmitting message-1-based on-demand other system information, or if the access procedure is a contention-free access procedure.

In some cases, the network entity 405a may stop a scheduling request prohibition timer based on transmitting the request to establish the active connection. For example, the network entity 405a may start a scheduling request prohibition timer based on transmitting the scheduling request as part of the scheduling-request-based access procedure. While the scheduling request prohibition timer is running (e.g., between transmitting the scheduling request and stopping the scheduling request prohibition timer), the network entity 405a may refrain from transmitting scheduling requests.

As shown by reference number 455, the network entity 405b may optionally transmit, and the network entity 405a may receive, a contention resolution message. In particular, if the scheduling-request-based access procedure is contention-based, the network entity 405a may monitor for a contention resolution message (e.g., a MAC-CE) within a time window (e.g., within a time period, prior to an expiration of a timer that is started when the network entity 405a transmits the request at 450). If the network entity 405a fails to detect the contention resolution message within the time window, the network entity 405a may retransmit the scheduling request if the quantity of retransmissions is less than the threshold (e.g., as described with reference to reference number 440) or fall back to a RACH procedure (e.g., as described with reference to reference number 445).

As shown by reference number 460, the network entity 405b may optionally transmit, and the network entity 405 may receive, an indication to establish an active connection. Based on receiving the indication, the network entity 405a may establish the active connection with the network entity 405b. The indication to establish the active connection may correspond to a downlink message that includes an RRC message for connection setup or resume. In some cases, the network entity 405b may transmit the indication to establish an active connection if the access procedure is for initial access, a short data transmission, or for transmitting on-demand other system information. In some cases, the network entity 405a may refrain from transmitting the indication to establish an active connection if the access procedure is for on-demand SIB1 transmission, for transmitting message 1-based on-demand other system information, or if the access procedure is a contention-free access procedure.

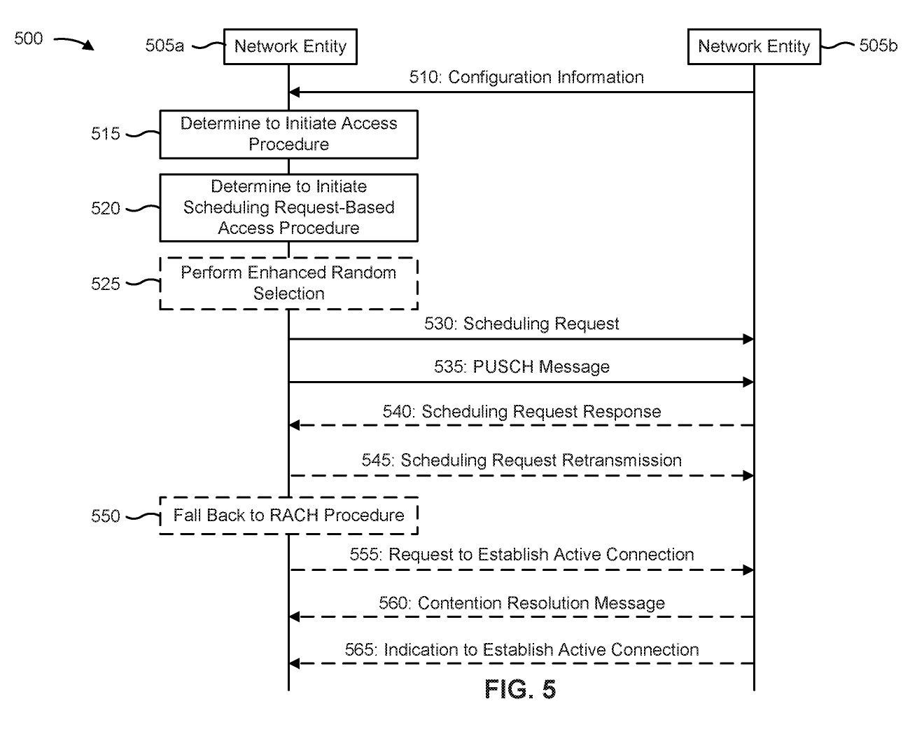

FIG. 5 is a diagram illustrating an example 500 associated with a scheduling-request-based access procedure. As shown in FIG. 5, a network entity 505a (e.g., a CPE device, an FWA device, or another stationary wireless communication device such as a cable modem) and a network entity 505b (e.g., a gNB or another network node described herein) may communicate with one another to perform the scheduling-request-based access procedure. In the example 500, the network entity 505a may transmit both a scheduling request and a PUSCH message as part of the scheduling-request-based access procedure (e.g., prior to receiving a scheduling request response).

As shown by reference number 510, the network entity 505b may transmit, and the network entity 505a may receive, configuration information for a scheduling-request-based access procedure. In some cases, the configuration information may correspond to the configuration information described with reference to FIG. 4. Additionally, the configuration information may indicate for the network entity 505a to transmit both a scheduling request and a PUSCH message as part of the scheduling-request-based access procedure. In some cases, the configuration information may indicate one or more parameters associated with the PUSCH message. For example, the configuration information may indicate resources for the PUSCH message. The resources for the PUSCH message may be shared among multiple network entities or dedicated to the network entity 505a. In particular, the resources for both the scheduling request and the PUSCH message may both be shared among multiple network entities. In another example, the resources for the scheduling request may be dedicated to the network entity 505a and the resources for the PUSCH message may be shared among multiple network entities. This may correspond to a many-to-one configuration, and may be associated with reduced resource overhead (as the resources for the PUSCH message are shared) while enabling the network entity 405b to detect potential collisions of the PUSCH message (e.g., based on the dedicated resources for the scheduling request). In another example, the resources for the scheduling request may be shared among multiple network entities and the resources for the PUSCH message may be dedicated to the network entity 505a. This may correspond to a one-to- many configuration, and may be associated with reduced overhead (e.g., as the resources of the scheduling resource are shared) and reduced power consumption by the network entity 505b (e.g., as the PUSCH is processed only if the network entity 505b detects the scheduling request).

As shown by reference number 515, the network entity 505a may determine to initiate an access procedure. In some cases, the network entity 505a may determine to initiate the access procedure as described with respect to reference number 415 in FIG. 4.

As shown by reference number 520, the network entity 505a may determine to initiate a scheduling-request-based access procedure. In some cases, the network entity 505a may determine to initiate the scheduling-request-based access procedure as described with respect to reference number 420 in FIG. 4.

As shown by reference number 525, the network entity 505a may optionally perform an enhanced random selection. In some cases, the network entity 505a may perform the enhanced random selection as described with respect to reference number 425 in FIG. 4.

As shown by reference number 530, the network entity 505a may transmit, and the network entity 505b may receive, a scheduling request. In some cases, the scheduling request may include aspects of the scheduling request described with reference to FIG. 4. Additionally, and as shown by reference number 535, the network entity 505a may transmit, and the network entity 505b may receive, a PUSCH message. In some cases, the PUSCH message may include a request to establish the active connection with the network entity 505b. Additionally, the network entity 505b may transmit the PUSCH message via resources that are either shared among multiple network entities or dedicated to the network entity 505a (e.g., as indicated by the configuration information). In some cases, the resources for the scheduling request and the PUSCH message may be multiplexed in the time, frequency, or spatial domain.

In some cases, a gap between the resources for the scheduling request and for the PUSCH message may be large enough that the network entity 505b may reallocate the resources for the PUSCH message if the network entity 505b does not detect the scheduling request. Additionally, if the configuration for the scheduling request and the PUSCH message corresponds to a many-to-one mapping (e.g., where the resources for the scheduling request are dedicated to the network entity 505a and the resources for the PUSCH message are shared), the network entity 505b may detect multiple scheduling requests, but be unable to decode one or more colliding PUSCH messages. Here, the network entity 505b may include separate uplink grants (e.g., in the subsequent scheduling request response message described with respect to reference number 540) for the colliding network entities to retransmit the PUSCH messages.

As shown by reference number 535, the network entity 505b may optionally transmit, and the network entity 505a may receive, a scheduling request response. The scheduling request response may include aspects of the scheduling request described with reference to FIG. 4.

As shown by reference number 545, the network entity 505a may optionally transmit, and the network entity 505b may receive, a scheduling request retransmission. The scheduling request retransmission may include aspects of the scheduling request retransmission described with reference to FIG. 4.

As shown by reference number 550, the network entity 505a may optionally fall back to a RACH procedure to establish the active connection with the network entity 505b. The fall back to the RACH procedure may include aspects of the fall back to the RACH procedure described with reference to FIG. 4.

As shown by reference number 555, the network entity 505a may optionally transmit, and the network entity 505b may receive, a request to establish an active connection. The request to establish the active connection may include aspects of the request to establish the active connection described with reference to FIG. 4.

As shown by reference number 560, the network entity 505b may optionally transmit, and the network entity 505a may receive, a contention resolution message. The contention resolution message may include aspects of the contention resolution message described with reference to FIG. 4.

As shown by reference number 565, the network entity 505b may optionally transmit, and the network entity 505 may receive, an indication to establish an active connection. The indication to establish the active connection may include aspects of the indication to establish the active connection described with reference to FIG. 4.

FIG. 6 is a diagram illustrating an example 600 of resources associated with a scheduling-request-based access procedure. In particular, the example 600 illustrates resources within a bandwidth part 605 that are associated with transmitting a scheduling request as part of a scheduling-request-based access procedure.

The bandwidth part 605 may be divided into multiple scheduling request resource subsets 610. In some cases, the bandwidth part 605 may also be divided into multiple subbands 615, and each subband 615 may include a plurality of scheduling request resource subsets 610. For example, the subband 615a may include the scheduling request resource subset 610a, the scheduling request resource subset 610b, and the scheduling request resource subset 610c; the subband 615b may include the scheduling request resource subset 610d, the scheduling request resource subset 610e, and the scheduling request resource subset 610f; and the subband 615c may include the scheduling request resource subset 610g, the scheduling request resource subset 610h, and the scheduling request resource subset 610i.

In some cases, a network entity (such as a network entity 405a or a network entity 505a) may select one of the scheduling request resource subsets 610 for transmitting the scheduling request. That is, each scheduling request resource subset 610 may include resources to carry a scheduling request. For example, if the scheduling request corresponds to a PUCCH format 0 message, the scheduling request resource subsets 610 may span one symbol and one resource block.

A network entity may select a scheduling request resource subset 610 based on a mapping between SSBs and scheduling request resource subsets 610 (e.g., indicated by the configuration information, predefined or otherwise preconfigured). Here, the mapping may indicate a plurality of scheduling request resource subsets 610 that are associated with each SSB. Then, the network entity may determine the scheduling request resource subset 610 by selecting one of the scheduling request resource subsets 610 from the plurality of scheduling request resource subsets 610 that are mapped to the SSB detected by the network entity. The network entity may calculate an SRR-RNTI based on an index associated with the selected scheduling request resource subset 610.

In a first example, the index associated with the selected scheduling request resource subset 610 may be defined based on a set of scheduling request resources (e.g., corresponding to the bandwidth part 605). That is, each of the scheduling request resource subsets 610 may be defined based on a time and frequency location of the scheduling request resource subset 610 within the bandwidth part 605 (e.g., within the set of scheduling request resources). Here, the index may be defined based on the cyclic shift and root sequence (u,v) of the scheduling request. In some cases, the resulting quantity of resource indices may be fewer than 64, as the quantity of cyclic shifts for PUCCH messages (including scheduling requests) is 12, and using too many different root sequences (u,v) may result in poor cross-correlation of the sequence (which may be short for scheduling requests).

In a second example, the index associated with the selected scheduling request resource subset 610 may be defined based on a frequency location of the scheduling request resource subset 610 within a subband 615. That is, the bandwidth part 605 may be divided into the multiple subbands 615, and the scheduling request resource subsets 610 may be defined based on a time occasion and subband index of the scheduling request resource subset 610. Therefore, the index may be based on the frequency location of the scheduling request resource subset 610 within the subband 615, the cyclic shift of the scheduling request, and the root sequence (u,v) of the scheduling request. The second example may result in more resource indices as compared to the first example.

As indicated above, FIG. 6 is provided as an example. Other examples may differ from what is described with regard to FIG. 6.

FIG. 7 is a diagram illustrating an example process 700 performed, for example, at a first network entity or an apparatus of a first network entity. Example process 700 is an example where the apparatus or the first network entity (e.g., network entity 405a, network entity 505a) performs operations associated with scheduling-request-based access procedures.

As shown in FIG. 7, in some aspects, process 700 may include receiving configuration information for a scheduling-request-based access procedure (block 710). For example, the first network entity (e.g., using reception component 902 or communication manager 906, depicted in FIG. 9) may receive configuration information for a scheduling-request-based access procedure, as described above.

As further shown in FIG. 7, in some aspects, process 700 may include transmitting, based on the configuration information, a scheduling request as part of the scheduling-request-based access procedure (block 720). For example, the first network entity (e.g., using transmission component 904 or communication manager 906, depicted in FIG. 9) may transmit, based on the configuration information, a scheduling request as part of the scheduling-request-based access procedure, as described above.

As further shown in FIG. 7, in some aspects, process 700 may include establishing an active connection with a second network entity based on the scheduling- request-based access procedure or based on a fallback RACH procedure performed after initiating the scheduling-request-based access procedure (block 730). For example, the first network entity (e.g., using communication manager 906, depicted in FIG. 9) may establish an active connection with a second network entity based on the scheduling-request-based access procedure or based on a fallback RACH procedure performed after initiating the scheduling-request-based access procedure, as described above.

Process 700 may include additional aspects, such as any single aspect or any combination of aspects described below or in connection with one or more other processes described elsewhere herein.

In a first aspect, process 700 includes determining to initiate the scheduling-request-based access procedure rather than a RACH procedure based on one or more conditions, from a plurality of conditions for initiating the scheduling-request-based access procedure, being satisfied.

In a second aspect, alone or in combination with the first aspect, the plurality of conditions comprise a signal quality of a downlink reference signal exceeding a threshold signal quality, timing advance information stored at the first network entity being valid, the scheduling-request-based access procedure being for an initial access procedure, a priority or latency requirement of arrival data satisfying a threshold requirement, a time until a next-occurring scheduling request occasion being less than a threshold time, and a quantity of transmissions of the scheduling request being less than a threshold quantity.

In a third aspect, alone or in combination with one or more of the first and second aspects, the configuration information includes a plurality of scheduling-request-based access procedure configurations, and performing the scheduling-request-based access procedure based on the configuration information comprises performing the scheduling-request-based access procedure based on a particular scheduling-request-based access procedure configuration from the plurality of scheduling-request-based access procedure configurations, wherein the particular scheduling-request-based access procedure configuration is based on the one or more conditions from the plurality of conditions being satisfied.

In a fourth aspect, alone or in combination with one or more of the first through third aspects, the configuration information indicates the plurality of conditions.

In a fifth aspect, alone or in combination with one or more of the first through fourth aspects, transmitting the scheduling request comprises transmitting the scheduling request according to timing advance information stored at the first network entity.

In a sixth aspect, alone or in combination with one or more of the first through fifth aspects, process 700 includes communicating with the second network entity according to the timing advance information stored at the first network entity, and transitioning a connection between the first network entity and the second network entity from an active state to an inactive state, wherein transmitting the scheduling request occurs while the connection between the first network entity and the second network entity is in the inactive state, and wherein establishing the active connection comprises transitioning the connection between the first network entity and the second network entity from the inactive state to the active state.

In a seventh aspect, alone or in combination with one or more of the first through sixth aspects, process 700 includes receiving, in response to the scheduling request, a scheduling request response from the second network entity, wherein establishing the active connection with the second network entity comprises establishing the active connection with the second network entity based on the scheduling request response.

In an eighth aspect, alone or in combination with one or more of the first through seventh aspects, the scheduling request response includes at least one of an uplink grant for an RRC request message, a downlink grant for a contention resolution message, timing advance adjustment information, information related to the scheduling request, or information for the scheduling request.

In a ninth aspect, alone or in combination with one or more of the first through eighth aspects, the scheduling request response includes the retransmission information for the scheduling request, and the retransmission information for the scheduling request indicates a power for a retransmission of the scheduling request, resources for the retransmission of the scheduling request, new configuration information for the retransmission of the scheduling request, or an indication for the first network entity to fall back to a RACH procedure to establish the active connection with the second network entity.

In a tenth aspect, alone or in combination with one or more of the first through ninth aspects, receiving the scheduling request response comprises receiving a physical downlink control channel message that comprises the scheduling request response.

In an eleventh aspect, alone or in combination with one or more of the first through tenth aspects, receiving the scheduling request response comprises receiving a physical downlink control channel message that comprises a grant for a physical downlink shared channel message, and receiving the physical downlink shared channel message that comprises the scheduling request response.

In a twelfth aspect, alone or in combination with one or more of the first through eleventh aspects, process 700 includes decoding the scheduling request response using an identifier stored at the first network entity, wherein the identifier is an SRR-RNTI that is based on a set of resources for transmitting the scheduling request, or a C-RNTI.

In a thirteenth aspect, alone or in combination with one or more of the first through twelfth aspects, process 700 includes retransmitting the scheduling request based on a failure to detect, within a time window indicated by the configuration information, a scheduling request response that comprises an acknowledgement of the scheduling request.

In a fourteenth aspect, alone or in combination with one or more of the first through thirteenth aspects, process 700 includes performing a RACH procedure based on the failure to detect, within the time window, the scheduling request response that comprises the acknowledgement of the scheduling request and based on a quantity of transmissions of the scheduling request satisfying a threshold quantity, and establishing the active connection is based on completing the RACH procedure.

In a fifteenth aspect, alone or in combination with one or more of the first through fourteenth aspects, a first transmission power for transmitting the scheduling request is less than a second transmission power for retransmitting the scheduling request.

In a sixteenth aspect, alone or in combination with one or more of the first through fifteenth aspects, process 700 includes determining a subset of resources, from a set of resources, for transmitting the scheduling request based on the scheduling-request-based access procedure being contention-based and based on a mapping between a detected synchronization signal block and the subset of resources.

In a seventeenth aspect, alone or in combination with one or more of the first through sixteenth aspects, the configuration information indicates the mapping.

In an eighteenth aspect, alone or in combination with one or more of the first through seventeenth aspects, the scheduling-request-based access procedure is contention-free, and transmitting the scheduling request comprises transmitting the scheduling request on dedicated resources allocated to the first network entity.

In a nineteenth aspect, alone or in combination with one or more of the first through eighteenth aspects, the configuration information indicates the dedicated resources.

In a twentieth aspect, alone or in combination with one or more of the first through nineteenth aspects, process 700 includes transmitting, based on the configuration information, a PUSCH message comprising a request to establish the active connection, wherein establishing the active connection is based on the PUSCH message.

In a twenty-first aspect, alone or in combination with one or more of the first through twentieth aspects, transmitting the PUSCH message comprises transmitting the PUSCH message by a plurality of resources that are dedicated for the first network entity or shared among multiple network entities.

In a twenty-second aspect, alone or in combination with one or more of the first through twenty-first aspects, process 700 includes transmitting, to the second network entity and after transmitting the scheduling request, a request to establish the active connection, wherein establishing the active connection is based on the request to establish the active connection.

In a twenty-third aspect, alone or in combination with one or more of the first through twenty-second aspects, process 700 includes receiving, from the second network entity and after transmitting the scheduling request, an indication to establish the active connection with the second network entity.

In a twenty-fourth aspect, alone or in combination with one or more of the first through twenty-third aspects, transmitting the scheduling request comprises transmitting the scheduling request within a PUCCH message.

In a twenty-fifth aspect, alone or in combination with one or more of the first through twenty-fourth aspects, the first network entity is a CPE or an FWA device.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a first network entity or an apparatus of a first network entity. Example process 800 is an example where the apparatus or the first network entity (e.g., network entity 405b, network entity 505b) performs operations associated with scheduling-request-based access procedures.

As shown in FIG. 8, in some aspects, process 800 may include transmitting, to a second network entity, configuration information for a scheduling-request-based access procedure (block 810). For example, the first network entity (e.g., using transmission component 1004 or communication manager 1006, depicted in FIG. 10) may transmit, to a second network entity, configuration information for a scheduling-request-based access procedure, as described above.

As further shown in FIG. 8, in some aspects, process 800 may include receiving, from the second network entity and based on the configuration information, a scheduling request as part of the scheduling-request-based access procedure (block 820). For example, the first network entity (e.g., using reception component 1002 or communication manager 1006, depicted in FIG. 10) may receive, from the second network entity and based on the configuration information, a scheduling request as part of the scheduling-request-based access procedure, as described above.

As further shown in FIG. 8, in some aspects, process 800 may include establishing an active connection with the second network entity based on the scheduling-request-based access procedure or based on a fallback RACH procedure performed after initiating the scheduling-request-based access procedure (block 830). For example, the first network entity (e.g., using communication manager 1006, depicted in FIG. 10) may establish an active connection with the second network entity based on the scheduling-request-based access procedure or based on a fallback RACH procedure performed after initiating the scheduling-request-based access procedure, as described above.

Process 800 may include additional aspects, such as any single aspect or any combination of aspects described below or in connection with one or more other processes described elsewhere herein.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a first network entity, or a first network entity may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 114, the communication manager 118, or the communication manager 250 described in connection with FIGS. 1 and 2. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 110, the processing system 112, or the processing system 240 described in connection with FIGS. 1 and 2) of the first network entity.

In some aspects, the apparatus 900 may be configured to perform one or more operations described herein in connection with FIGS. 3-6. Additionally, or alternatively, the apparatus 900 may be configured to perform one or more processes described herein, such as process 700 of FIG. 7. In some aspects, the apparatus 900 or one or more components shown in FIG. 9 may include one or more components of the first network entity described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the first network entity described above in connection with FIG. 1, such as a radio, one or more RF chains, one or more transceivers, or one or more modems, each of which may in turn be coupled with one or more antennas of the first network entity.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the first network entity described above in connection with FIG. 1, such as a radio, one or more RF chains, one or more transceivers, or one or more modems, each of which may in turn be coupled with one or more antennas of the first network entity described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive configuration information for a scheduling-request-based access procedure. The transmission component 904 may transmit, based on the configuration information, a scheduling request as part of the scheduling-request-based access procedure. The communication manager 906 may establish an active connection with a second network entity based on the scheduling-request-based access procedure or based on a fallback RACH procedure performed after initiating the scheduling-request-based access procedure.

The communication manager 906 may determine to initiate the scheduling-request-based access procedure rather than a RACH procedure based on one or more conditions, from a plurality of conditions for initiating the scheduling-request-based access procedure, being satisfied.

The communication manager 906 may communicate with the second network entity according to the timing advance information stored at the first network entity.

The communication manager 906 may transition a connection between the first network entity and the second network entity from an active state to an inactive state.

The reception component 902 may receive, in response to the scheduling request, a scheduling request response from the second network entity.

The communication manager 906 may establish the active connection with the second network entity based on the scheduling request response.

The communication manager 906 may decode the scheduling request response using an identifier stored at the first network entity, wherein the identifier is an SRR-RNTI that is based on a set of resources for transmitting the scheduling request, or a C-RNTI.

The transmission component 904 may retransmit the scheduling request based on a failure to detect, within a time window indicated by the configuration information, a scheduling request response that comprises an acknowledgement of the scheduling request.

The communication manager 906 may perform a RACH procedure based on the failure to detect, within the time window, the scheduling request response that comprises the acknowledgement of the scheduling request and based on a quantity of transmissions of the scheduling request satisfying a threshold quantity.

The communication manager 906 may determine a subset of resources, from a set of resources, for transmitting the scheduling request based on the scheduling-request-based access procedure being contention-based and based on a mapping between a detected synchronization signal block and the subset of resources.

The transmission component 904 may transmit, based on the configuration information, a PUSCH message comprising a request to establish the active connection, wherein establishing the active connection is based on the PUSCH message.

The transmission component 904 may transmit, to the second network entity and after transmitting the scheduling request, a request to establish the active connection, wherein establishing the active connection is based on the request to establish the active connection.

The reception component 902 may receive, from the second network entity and after transmitting the scheduling request, an indication to establish the active connection with the second network entity.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a first network entity, or a first network entity may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 114, the communication manager 118, or the communication manager 255 described in connection with FIGS. 1 and 2. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 110, the processing system 112, or the processing system 245 described in connection with FIGS. 1 and 2) of the first network entity.

In some aspects, the apparatus 1000 may be configured to perform one or more operations described herein in connection with FIGS. 3-6. Additionally, or alternatively, the apparatus 1000 may be configured to perform one or more processes described herein, such as process 800 of FIG. 8. In some aspects, the apparatus 1000 or one or more components shown in FIG. 10 may include one or more components of the first network entity described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the first network entity described above in connection with FIG. 1, such as a radio, one or more RF chains, one or more transceivers, or one or more modems, each of which may in turn be coupled with one or more antennas of the first network entity.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the first network entity described above in connection with FIG. 1, such as a radio, one or more RF chains, one or more transceivers, or one or more modems, each of which may in turn be coupled with one or more antennas of the first network entity described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit, to a second network entity, configuration information for a scheduling-request-based access procedure. The reception component 1002 may receive, from the second network entity and based on the configuration information, a scheduling request as part of the scheduling-request-based access procedure. The communication manager 1006 may establish an active connection with the second network entity based on the scheduling-request-based access procedure or based on a fallback RACH procedure performed after initiating the scheduling-request-based access procedure.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a first network entity, comprising: receiving configuration information for a scheduling-request-based access procedure; transmitting, based on the configuration information, a scheduling request as part of the scheduling-request-based access procedure; and establishing an active connection with a second network entity based on the scheduling-request-based access procedure or based on a fallback RACH procedure performed after initiating the scheduling-request-based access procedure.

Aspect 2: The method of Aspect 1, further comprising: determining to initiate the scheduling-request-based access procedure rather than a RACH procedure based on one or more conditions, from a plurality of conditions for initiating the scheduling-request-based access procedure, being satisfied.

Aspect 3: The method of Aspect 2, wherein the plurality of conditions comprise: a signal quality of a downlink reference signal exceeding a threshold signal quality; timing advance information stored at the first network entity being valid; the scheduling-request-based access procedure being for an initial access procedure; a priority or latency requirement of arrival data satisfying a threshold requirement; a time until a next-occurring scheduling request occasion being less than a threshold time; and a quantity of transmissions of the scheduling request being less than a threshold quantity.

Aspect 4: The method of Aspect 2, wherein the configuration information includes a plurality of scheduling-request-based access procedure configurations, and performing the scheduling-request-based access procedure based on the configuration information comprises: performing the scheduling-request-based access procedure based on a particular scheduling-request-based access procedure configuration from the plurality of scheduling-request-based access procedure configurations, wherein the particular scheduling-request-based access procedure configuration is based on the one or more conditions from the plurality of conditions being satisfied.

Aspect 5: The method of Aspect 2, wherein the configuration information indicates the plurality of conditions.

Aspect 6: The method of any of Aspects 1-5, wherein transmitting the scheduling request comprises: transmitting the scheduling request according to timing advance information stored at the first network entity.

Aspect 7: The method of Aspect 6, further comprising: communicating with the second network entity according to the timing advance information stored at the first network entity; and transitioning a connection between the first network entity and the second network entity from an active state to an inactive state, wherein transmitting the scheduling request occurs while the connection between the first network entity and the second network entity is in the inactive state, and wherein establishing the active connection comprises: transitioning the connection between the first network entity and the second network entity from the inactive state to the active state.

Aspect 8: The method of any of Aspects 1-7, further comprising: receiving, in response to the scheduling request, a scheduling request response from the second network entity, wherein establishing the active connection with the second network entity comprises: establishing the active connection with the second network entity based on the scheduling request response.

Aspect 9: The method of Aspect 8, wherein the scheduling request response includes at least one of: an uplink grant for an RRC request message, a downlink grant for a contention resolution message, timing advance adjustment information, feedback information related to the scheduling request, or retransmission information for the scheduling request.

Aspect 10: The method of Aspect 9, wherein the scheduling request response includes the retransmission information for the scheduling request, and wherein the retransmission information for the scheduling request indicates: a power for a retransmission of the scheduling request; resources for the retransmission of the scheduling request; new configuration information for the retransmission of the scheduling request; or an indication for the first network entity to fall back to a RACH procedure to establish the active connection with the second network entity.

Aspect 11: The method of Aspect 8, wherein receiving the scheduling request response comprises: receiving a physical downlink control channel message that comprises the scheduling request response.

Aspect 12: The method of Aspect 8, wherein receiving the scheduling request response comprises: receiving a physical downlink control channel message that comprises a grant for a physical downlink shared channel message; and receiving the physical downlink shared channel message that comprises the scheduling request response.

Aspect 13: The method of Aspect 8, further comprising: decoding the scheduling request response using an identifier stored at the first network entity, wherein the identifier is an SRR-RNTI that is based on a set of resources for transmitting the scheduling request, or a C-RNTI.

Aspect 14: The method of any of Aspects 1-13, further comprising: retransmitting the scheduling request based on a failure to detect, within a time window indicated by the configuration information, a scheduling request response that comprises an acknowledgement of the scheduling request.

Aspect 15: The method of Aspect 14, further comprising: perform a RACH procedure based on the failure to detect, within the time window, the scheduling request response that comprises the acknowledgement of the scheduling request and based on a quantity of transmissions of the scheduling request satisfying a threshold quantity, and wherein establishing the active connection is based on completing the RACH procedure.

Aspect 16: The method of Aspect 14, wherein a first transmission power for transmitting the scheduling request is less than a second transmission power for retransmitting the scheduling request.

Aspect 17: The method of any of Aspects 1-16, further comprising: determining a subset of resources, from a set of resources, for transmitting the scheduling request based on the scheduling-request-based access procedure being contention-based and based on a mapping between a detected synchronization signal block and the subset of resources.

Aspect 18: The method of Aspect 17, wherein the configuration information indicates the mapping.

Aspect 19: The method of any of Aspects 1-18, wherein the scheduling-request-based access procedure is contention-free and wherein transmitting the scheduling request comprises: transmitting the scheduling request on dedicated resources allocated to the first network entity.

Aspect 20: The method of Aspect 19, wherein the configuration information indicates the dedicated resources.

Aspect 21: The method of any of Aspects 1-20, further comprising: transmitting, based on the configuration information, a PUSCH message comprising a request to establish the active connection, wherein establishing the active connection is based on the PUSCH message.

Aspect 22: The method of Aspect 21, wherein transmitting the PUSCH message comprises: transmitting the PUSCH message by a plurality of resources that are dedicated for the first network entity or shared among multiple network entities.

Aspect 23: The method of any of Aspects 1-22, further comprising: transmitting, to the second network entity and after transmitting the scheduling request, a request to establish the active connection, wherein establishing the active connection is based on the request to establish the active connection.

Aspect 24: The method of any of Aspects 1-23, further comprising: receiving, from the second network entity and after transmitting the scheduling request, an indication to establish the active connection with the second network entity.

Aspect 25: The method of any of Aspects 1-24, wherein transmitting the scheduling request comprises: transmitting the scheduling request within a PUCCH message.

Aspect 26: The method of any of Aspects 1-25, wherein the first network entity is a CPE or a FWA device.

Aspect 30: A method of wireless communication performed by a first network entity, comprising: transmitting, to a second network entity, configuration information for a scheduling-request-based access procedure; receiving, from the second network entity and based on the configuration information, a scheduling request as part of the scheduling-request-based access procedure; and establishing an active connection with the second network entity based on the scheduling-request-based access procedure or based on a fallback RACH procedure performed after initiating the scheduling-request-based access procedure.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A non-transitory computer-readable medium having instructions stored thereon that, when executed by a first network entity, causes the first network entity to perform the method of one or more of Aspects of 1-30.

Aspect 37: A device for wireless communication, the device comprising a processing system that includes one or more processors and one or more memories coupled with the one or more processors, the processing system configured to cause the device to perform the method of one or more of Aspects 1-30.

Aspect 38: An apparatus for wireless communication at a device, the apparatus comprising one or more memories and one or more processors coupled to the one or more memories, the one or more processors individually or collectively configured to cause the device to perform the method of one or more of Aspects 1-30.

Aspect 39: A device comprising a processing system that includes one or more processors and one or more code-storing memories coupled with the one or more processors, the processing system configured to cause the device to perform the method of one or more of Aspects 1-30.

Aspect 40: A device comprising a processing system that includes processor circuitry and code-storing memory circuitry, the processing system configured to cause the device to perform the method of one or more of Aspects 1-30.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

Systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A first network entity, comprising:
a processing system configured to:
receive configuration information for a scheduling-request-based access procedure;
transmit, based on the configuration information, a scheduling request as part of the scheduling-request-based access procedure; and
establish an active connection with a second network entity based on the scheduling-request-based access procedure or based on a fallback random access channel procedure performed after initiation of the scheduling-request-based access procedure.

2. The first network entity of claim 1, wherein the processing system is configured to:
determine to initiate the scheduling-request-based access procedure rather than a random access channel procedure based on one or more conditions, from a plurality of conditions for initiation of the scheduling-request-based access procedure, being satisfied.

3. The first network entity of claim 2, wherein the plurality of conditions comprise:
a signal quality of a downlink reference signal exceeding a threshold signal quality;
timing advance information stored at the first network entity being valid;
the scheduling-request-based access procedure being for an initial access procedure;
a priority or latency requirement of arrival data satisfying a threshold requirement;
a time until a next-occurring scheduling request occasion being less than a threshold time; and
a quantity of transmissions of the scheduling request being less than a threshold quantity.

4. The first network entity of claim 2, wherein the configuration information includes a plurality of scheduling-request-based access procedure configurations, and wherein, to perform the scheduling-request-based access procedure based on the configuration information, the processing system is configured to:
perform the scheduling-request-based access procedure based on a particular scheduling-request-based access procedure configuration from the plurality of scheduling-request-based access procedure configurations, wherein the particular scheduling-request-based access procedure configuration is based on the one or more conditions from the plurality of conditions being satisfied.

5. The first network entity of claim 2, wherein the configuration information indicates the plurality of conditions.

6. The first network entity of claim 1, wherein, to transmit the scheduling request, the processing system is configured to:
transmit the scheduling request according to timing advance information stored at the first network entity.

7. The first network entity of claim 6, wherein the processing system is configured to:
communicate with the second network entity according to the timing advance information stored at the first network entity; and
transition a connection between the first network entity and the second network entity from an active state to an inactive state, wherein the transmission of the scheduling request occurs while the connection between the first network entity and the second network entity is in the inactive state, and wherein, to establish the active connection, the processing system is configured to:
transition the connection between the first network entity and the second network entity from the inactive state to the active state.

8. The first network entity of claim 1, wherein the processing system is configured to:
receive, in response to the scheduling request, a scheduling request response from the second network entity, wherein, to establish the active connection with the second network entity, the processing system is configured to:
establish the active connection with the second network entity based on the scheduling request response.

9. The first network entity of claim 8, wherein the scheduling request response includes at least one of:
an uplink grant for a radio resource control (RRC) request message,
a downlink grant for a contention resolution message,
timing advance adjustment information,
feedback information related to the scheduling request, or
retransmission information for the scheduling request.

10. The first network entity of claim 8, wherein, to receive the scheduling request response, the processing system is configured to:
receive a physical downlink control channel message that comprises the scheduling request response.

11. The first network entity of claim 8, wherein, to receive the scheduling request response, the processing system is configured to:
receive a physical downlink control channel message that comprises a grant for a physical downlink shared channel message; and
receive the physical downlink shared channel message that comprises the scheduling request response.

12. The first network entity of claim 8, wherein the processing system is configured to:
decode the scheduling request response using an identifier stored at the first network entity, wherein the identifier is a scheduling request resource radio network temporary identifier (SRR-RNTI) that is based on a set of resources for the transmission of the scheduling request, or a cell radio network temporary identifier (C-RNTI).

13. The first network entity of claim 1, wherein the processing system is configured to:
retransmit the scheduling request based on a failure to detect, within a time window indicated by the configuration information, a scheduling request response that comprises an acknowledgement of the scheduling request.

14. The first network entity of claim 13, wherein the processing system is configured to:
perform a random access channel procedure based on the failure to detect, within the time window, the scheduling request response that comprises the acknowledgement of the scheduling request and based on a quantity of transmissions of the scheduling request satisfying a threshold quantity, and wherein the establishment of the active connection is based on a completion of the random access channel procedure.

15. The first network entity of claim 1, wherein the processing system is configured to:
determine a subset of resources, from a set of resources, for the transmission of the scheduling request based on the scheduling-request-based access procedure being contention-based and based on a mapping between a detected synchronization signal block and the subset of resources.

16. The first network entity of claim 1, wherein the scheduling-request-based access procedure is contention-free and wherein, to transmit the scheduling request, the processing system is configured to:
transmit the scheduling request on dedicated resources allocated to the first network entity.

17. The first network entity of claim 1, wherein the processing system is configured to:
transmit, based on the configuration information, a physical uplink shared channel message comprising a request to establish the active connection, wherein the establishment of the active connection is based on the physical uplink shared channel message.

18. The first network entity of claim 1, wherein the processing system is configured to:
transmit, to the second network entity and after the transmission of the scheduling request, a request to establish the active connection, wherein the establishment of the active connection is based on the request to establish the active connection.

19. A method of wireless communication performed by a first network entity, comprising:
receiving configuration information for a scheduling-request-based access procedure;
transmitting, based on the configuration information, a scheduling request as part of the scheduling-request-based access procedure; and
establishing an active connection with a second network entity based on the scheduling-request-based access procedure or based on a fallback random access channel procedure performed after initiating the scheduling-request-based access procedure.

20. A non-transitory computer-readable medium having instructions stored thereon that, when executed by a first network entity, causes the first network entity to:
receive configuration information for a scheduling-request-based access procedure;
transmit a scheduling request as part of the scheduling-request-based access procedure; and
establish an active connection with a second network entity based on the scheduling-request-based access procedure or based on a fallback random access channel procedure performed after initiating the scheduling-request-based access procedure.
